(19) United States
(12) Patent Application Publication
(10) Pub. No.: US 2022/0334576 A1
(43) Pub. Date: Oct. 20, 2022

(54) MONITORING METHOD, MONITORING DEVICE, STORAGE MEDIUM

(71) Applicant: NEC Corporation, Minato-ku, Tokyo (JP)

(72) Inventor: Naoki YOSHINAGA, Tokyo (JP)

(73) Assignee: NEC Corporation, Minato-ku, Tokyo (JP)

(21) Appl. No.: 17/617,057

(22) PCT Filed: Jun. 10, 2019
(86) PCT No.: PCT/JP2019/022956

§ 371 Date: Dec. 7, 2021

(51) Int. Cl. G05B 23/02

(52) U.S. Cl. CPC G05B 23/0259

(57) ABSTRACT

A monitoring method, to be performed by a monitoring device that performs analysis of time-series data, includes calculating statistical information corresponding to a comparison result between time-series data of a search object and past time-series data, and outputting the calculated statistical information.

### TECHNICAL FIELD

The present invention relates to a monitoring method, a monitoring device, and a storage medium.

### BACKGROUND ART

In plants and facilities, time-series data of observation values acquired by various sensors is analyzed, and occurrence of an abnormal state is detected.

As one of such art for performing abnormal detection, Patent Literature 1 has been known. Patent Literature 1 discloses an abnormality sign detection system including a data collection unit, a normal class table, a feature amount extraction unit, a normal/abnormal determination unit, and a normal pattern learning unit. According to Patent Literature 1, after the normal/abnormality determination unit performs first determination processing to determine whether the feature amount in a frame unit extracted by a feature amount extraction unit is normal or abnormal by using normal class data registered in a normal class table as a discriminator, the normal/abnormality determination unit performs second determination processing to determine whether segment data is normal or abnormal. Further, a normal pattern learning unit determines whether or not a normal class, corresponding to data determined to be normal by the second determination processing performed by the normal/abnormal determination unit, exists in the normal class table, during the learning period having been set, and when it does not exist, generates data determined to be normal as a new normal class and registers it with the normal class table.
Patent Literature 1: JP 2017-102765 A
Non-Patent Literature 1: Dongjin Song (NEC Labs America); Ning Xia (NEC Labs America); Wei Cheng (NEC Labs America); Haifeng Chen (NEC Labs America); Dacheng Tao (The University of Sydney), Deep r-th Root of Rank Supervised Joint Binary Embedding for Multivariate Time Series Retrieval, KDD 2018, Aug. 19-23, 2018

### SUMMARY

In order that a user determines abnormality correctly, it is desirable to present, to the user, not only information indicating that an abnormality is detected but also more detailed information. However, in the case of the technology described in Patent Literature 1, only abnormality notification processing is performed, which consequently causes a problem that information sufficient for determining abnormality cannot be presented to the user.

In view of the above, an object of the present invention is to provide a monitoring method, a monitoring device, and a storage medium, for solving the problem that it is difficult to present sufficient information for performing abnormality determination to a user.

In order to achieve the object, a monitoring method, according to one aspect of the present invention, is a monitoring method to be performed by a monitoring device that performs analysis of time-series data. The method is configured to include

calculating statistical information corresponding to a comparison result between time-series data of a search object and past time-series data, and outputting the calculated statistical information.

Further, a monitoring device, according to another aspect of the present invention, is configured to include

a calculation unit that calculates statistical information corresponding to a comparison result between time-series data of a search object and past time-series data, and

an output unit that outputs the statistical information calculated by the calculation unit.

Further, a storage medium, according to another aspect of the present invention, is a computer-readable storage medium storing thereon a program for causing a monitoring device to realize

a calculation unit that calculates statistical information corresponding to a comparison result between time-series data of a search object and past time-series data, and an output unit that outputs the statistical information calculated by the calculation unit.

With the configurations described above, the present invention is able to provide a monitoring method, a monitoring device, and a storage medium, for solving the problem that it is difficult to present sufficient information for performing abnormality determination to a user.

### BRIEF DESCRIPTION OF DRAWINGS

FIG. 1 illustrates an exemplary configuration of the entire system to which the present invention is applied.

FIG. 2 is a block diagram illustrating an exemplary configuration of the monitoring device illustrated in FIG. 1.

FIG. 3 illustrates an example of past time-series information.

FIG. 4 illustrates an example of abnormal case information.

FIG. 5 illustrates an example of past time-series feature amount information.

FIG. 6 illustrates an example of feature amount calculation processing.

FIG. 7 illustrates an example of feature amount calculation processing.

FIG. 8 illustrates an example of feature amount calculation processing.

FIG. 9 illustrates an exemplary display of a result display unit.

FIG. 10 is a flowchart showing an example of processing by a monitoring device.

FIG. 11 is a flowchart showing another example of processing by the monitoring device.

FIG. 12 illustrates another example of a search object.

FIG. 13 illustrates an example of processing to aggregate ranking results.

FIG. 14 is a block diagram illustrating an exemplary configuration of a monitoring device according to a second exemplary embodiment of the present invention.

### EXEMPLARY EMBODIMENTS

### First Exemplary Embodiment

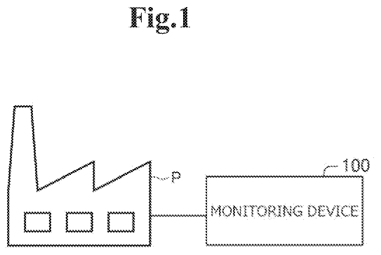

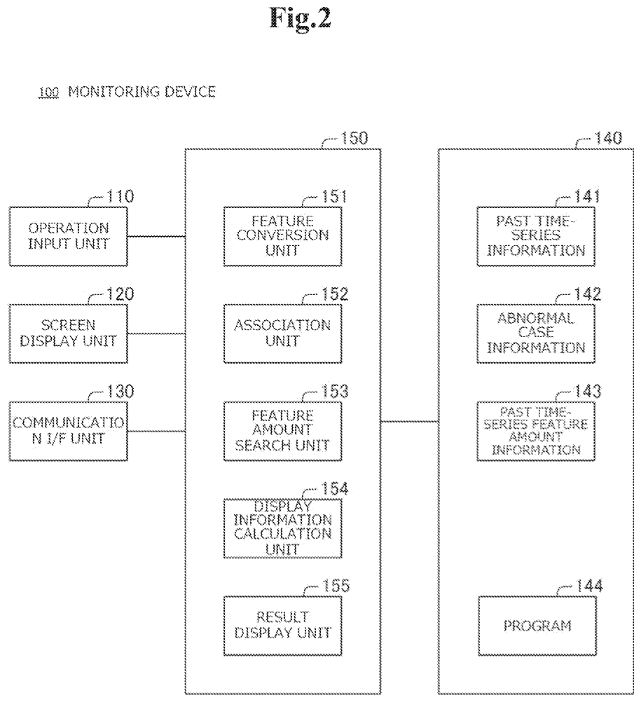

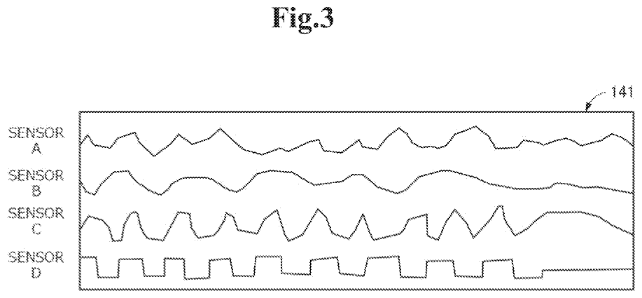

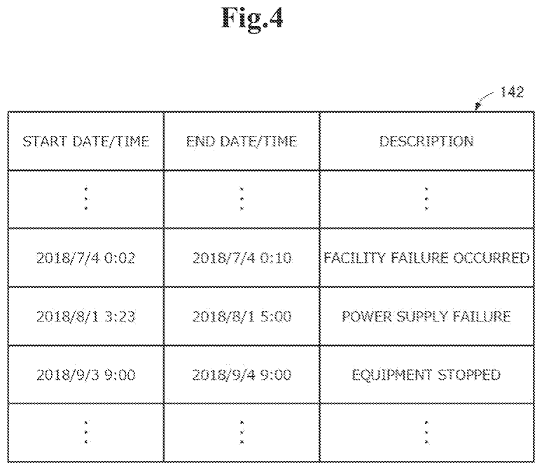

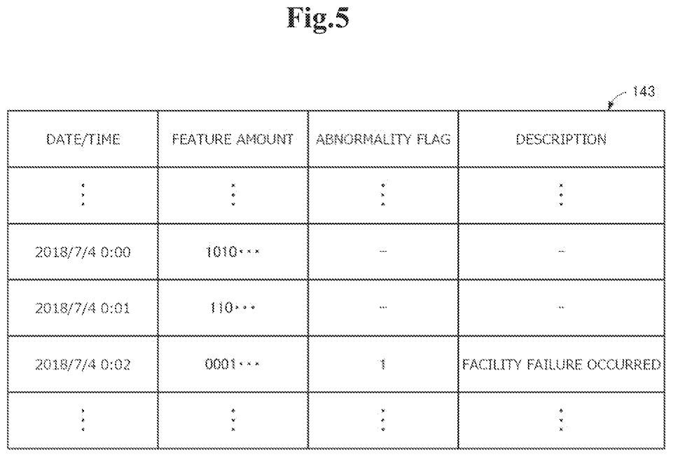

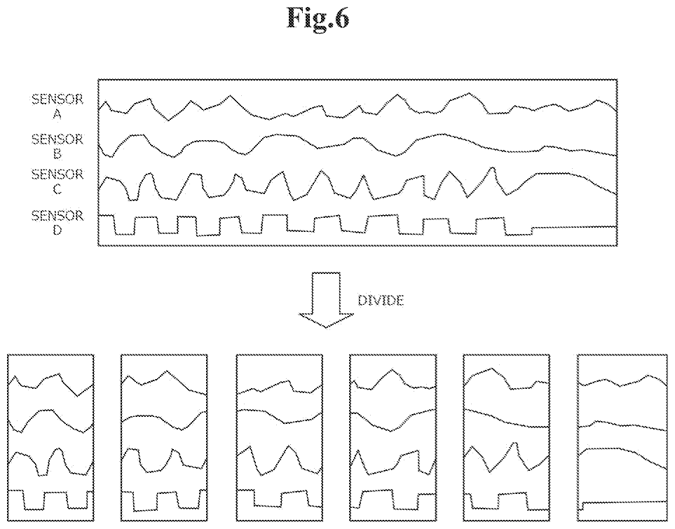

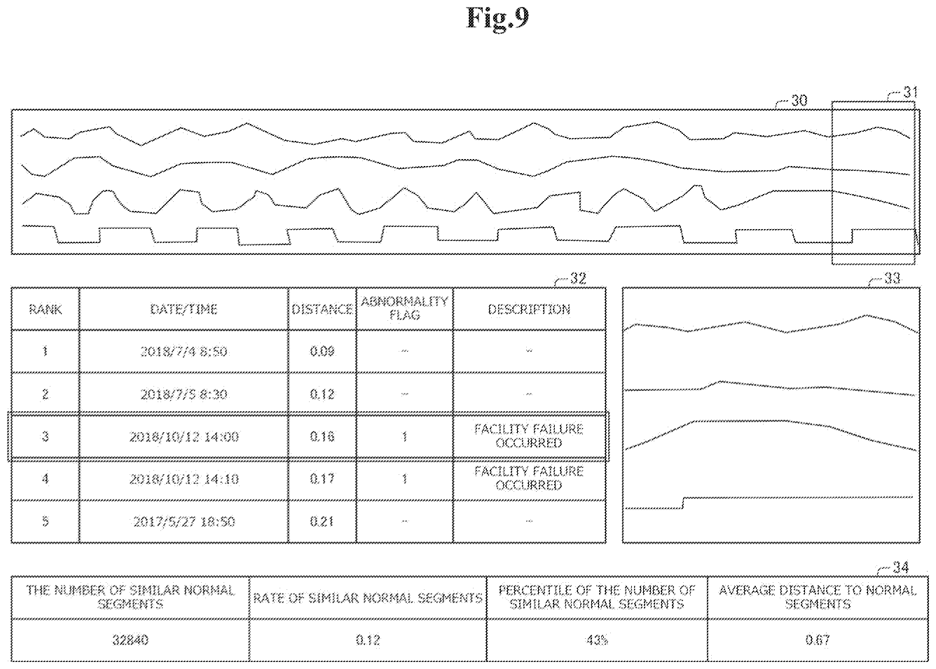

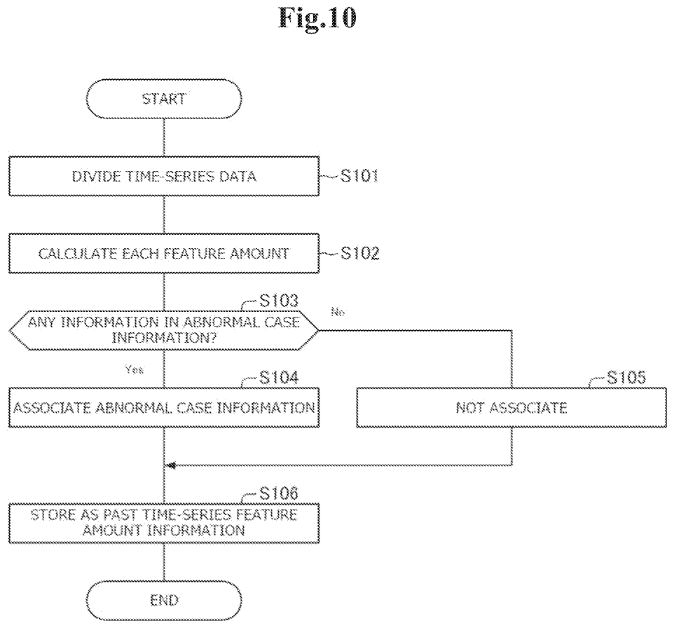

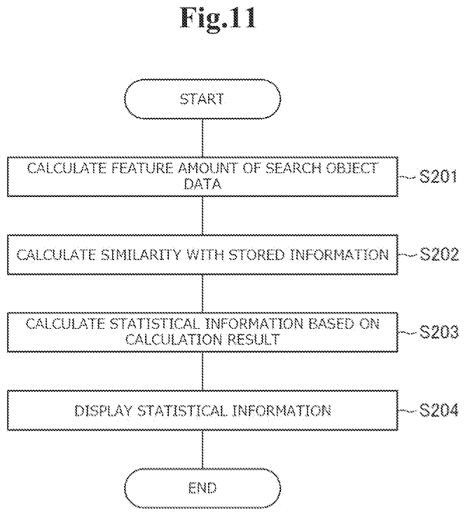

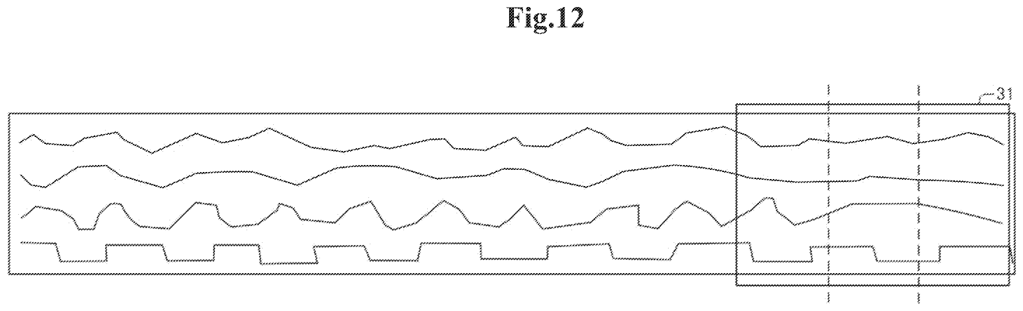

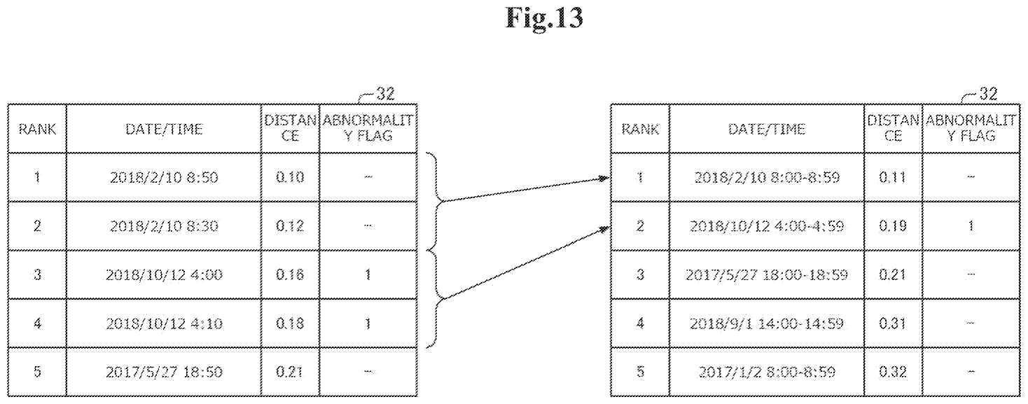

A first exemplary embodiment of the present invention will be described with reference to FIGS. 1 to 13. FIG. 1 illustrates an exemplary configuration of the entire system to which the present invention is applied. FIG. 2 is a block diagram illustrating an exemplary configuration of a monitoring device 100. FIG. 3 illustrates an example of past time-series information 141. FIG. 4 illustrates an example of abnormal case information 142. FIG. 5 illustrates an example of past time-series feature amount information 143. FIGS. 6 to 8 illustrate an example of feature amount calculation processing. FIG. 9 illustrates an exemplary display of a result display unit 155. FIGS. 10 and 11 are flowcharts showing examples of processing by the monitoring device 100. FIG. 12 illustrates another example of a search object. FIG. 13 illustrates an example of processing to aggregate ranking results.

In the first exemplary embodiment of the present invention, the monitoring device 100 configured to analyze time-series data and output the analysis result will be described. As described below, in the present embodiment, the monitoring device 100 calculates various types of statistical information such as one in which results of comparing search object data with the entire past data are listed in a ranking format. Then, the monitoring device 100 outputs the calculated statistical information.

FIG. 1 illustrates an exemplary configuration of the entire system to which the present invention is applied. Referring to FIG. 1, the monitoring device 100 of the present invention is connected with a monitoring object P (object) such as a plant over a network. The monitoring device 100 acquires various measurement values measured by various sensors provided to the monitoring object P, from the monitoring object P over the network or the like.

Note that the monitoring object P is, for example, a plant such as a production facility or a processing facility. The monitoring object P may be an object other than those illustrated above, such as an information processing system. Further, various measurement values include, for example, temperature, pressure, flow rate, power consumption value, material supply amount, residual amount, and the like in the plant. The various measurement values may be values other than those illustrated above, as similar to the case of the monitoring object P. For example, when the monitoring object P is an information processing system, the various measurement values may be utilization of the central processing unit (CPU), memory utilization, disk access frequency, the number of input/output packets, power consumption value, and the like of each information processing device constituting the information processing system.

FIG. 2 illustrates an exemplary configuration of the monitoring device 100. Referring to FIG. 2, the monitoring device 100 includes, as main constituent elements, an operation input unit 110, a screen display unit 120, a communication I/F unit 130, a storage unit 140, and an arithmetic processing unit 150.

The operation input unit 110 is configured of operation input devices such as a keyboard and a mouse. The operation input unit 110 detects operation by a user who operates the monitoring device 100, and outputs it to the arithmetic processing unit 150.

The screen display unit 120 is configured of a screen display device such as a liquid crystal display (LCD). The screen display unit 120 displays various types of statistical information, described below, in accordance with an instruction from the arithmetic processing unit 150.

The communication I/F unit 130 is configured of a data communication circuit. The communication I/F unit 130 has a function of performing data communication with various devices connected over a communication network. For example, the monitoring device 100 acquires various measurement values from the monitoring object P via the communication I/F unit 130.

The storage unit 140 is configured of storage devices such as a hard disk and a memory. The storage unit 140 stores processing information and a program 144 required for various types of processing performed in the arithmetic processing unit 150. The program 144 is read and executed by the arithmetic processing unit 150 to thereby implement various processing units. The program 144 is read in advance from an external device or a storage medium via the data input/output function of the communication I/F unit 130 and the like, and is stored in the storage unit 140. Main information stored in the storage unit 140 includes, for example, past time-series information 141, abnormal case information 142, and past time-series feature amount information 143.

The past time-series information 141 includes time-series data formed of measurement values measured at predetermined time intervals by various sensors that are provided to the monitoring object P. For example, when the monitoring device 100 acquires time-series data from the monitoring object P, the monitoring device 100 stores the acquired time-series data in the storage unit 140 as the past time-series information 141. The monitoring device 100 may be configured to periodically acquire various measurement values from the monitoring object P at predetermined time intervals and store them in the storage unit 140 from time to time.

FIG. 3 illustrates an example of the past time-series information 141. For example, in the case of FIG. 3, the past time-series information 141 includes time-series data of measurement values acquired by each of four types of sensors namely a sensor A, a sensor B, a sensor C, and a sensor D.

FIG. 3 illustrates an example of the past time-series information 141 is illustrated. The past time-series information 141 is not limited to that illustrated in FIG. 3. For example, the past time-series information 141 may include a type of time-series data other than the four types.

The abnormal case information 142 is information indicating abnormality that occurred in the monitoring object P. For example, when the monitoring device 100 acquires information about an occurrence of abnormality from an external device such as the monitoring object P, the monitoring device 100 stores the acquired information about the occurrence of abnormality in the storage unit 140 as the abnormal case information 142.

FIG. 4 illustrates an example of the abnormal case information 142. Referring to FIG. 4, in the abnormal case information 142, “start date/time” indicating the date and time that an abnormality started, “end date/time” indicating the date and time that the abnormality ended, and “description” indicating the content of the occurred abnormality, are associated with each other for example. For example, on the second line of FIG. 4, “start date/time: 2018/7/4 0:02”, “end date/time: 2018/7/4 0:10”, and “description: facility failure occurred” are associated with each other.

As described above, the abnormal case information 142 includes information indicating the period of time during which abnormality occurred in the monitoring object P. Note that FIG. 4 illustrates an example of the abnormal case information 142. The abnormal case information 142 is not limited to that illustrated in FIG. 4.

The past time-series feature amount information 143 is information indicating the feature amount of each segment described below. The past time-series feature amount information 143 is generated by, for example, associating the feature amount of each segment calculated by a feature conversion unit 151 described below with the information indicated by the abnormal case information 142, by the association unit 152.

FIG. 5 illustrates an example of the past time-series feature amount information 143. Referring to FIG. 5, in the past time-series feature amount information 143, “date/time” indicating the period (time) of the segment, “feature amount” indicating the value of the feature amount, “abnormality flag” indicating whether or not an abnormality has occurred at the time indicated by the “date/time” in the monitoring object P, and “description” indicating the content of the occurred abnormality, are associated with one another, for example. For example, on the second line of FIG. 5, the “date/time: 2018/7/4 0:00”, “feature amount: 1010 . . . ”, “abnormality flag: -”, and “description: -” are associated with one another.

As described above, the past time-series feature amount information 143 includes information indicating the feature amount of the segment, and information indicating whether or not an abnormality has occurred in the monitoring object P in the period of the segment. Note that FIG. 5 illustrates an example of the past time-series feature amount information 143. The past time-series feature amount information 143 is not limited to that illustrated in FIG. 5. For example, the past time-series feature amount information 143 may be configured of some of the information illustrated in FIG. 5, without including “abnormality flag” or “description”.

The arithmetic processing unit 150 has a microprocessor such as an MPU and the peripheral circuits, and is configured to read and execute the program 144 from the storage unit 140 to allow the hardware and the program 144 to cooperate with each other to thereby implement the various processing units. The main processing units implemented by the arithmetic processing unit 15 include, for example, the feature conversion unit 151, the association unit 152, a feature amount search unit 153, a display information calculation unit 154, and a result display unit 155.

The feature conversion unit 151 calculates the feature amount from the time-series data indicated by the past time-series information 141. FIG. 6 illustrates an example of processing for calculating the feature amount by the feature conversion unit 151. Referring to FIG. 6, the feature conversion unit 151 divides time-series data into a plurality of segments each of which is partial time-series data (partial time-series). For example, the feature conversion unit 151 divides time-series data into a plurality of segments according to a search unit described below, such as by several points of measurement value (for example, by 10 points of measurement value, or by the measurement value measured in one minute). Then, the feature conversion unit 151 calculates the feature amount of each divided segment.

The feature conversion unit 151 calculates the feature amount such that the data becomes sufficiently smaller than the original data such as a binary string of several hundreds bits. In the present embodiment, a method used when the feature conversion unit 151 calculates the feature amount is not limited particularly if it enables the data to be small.

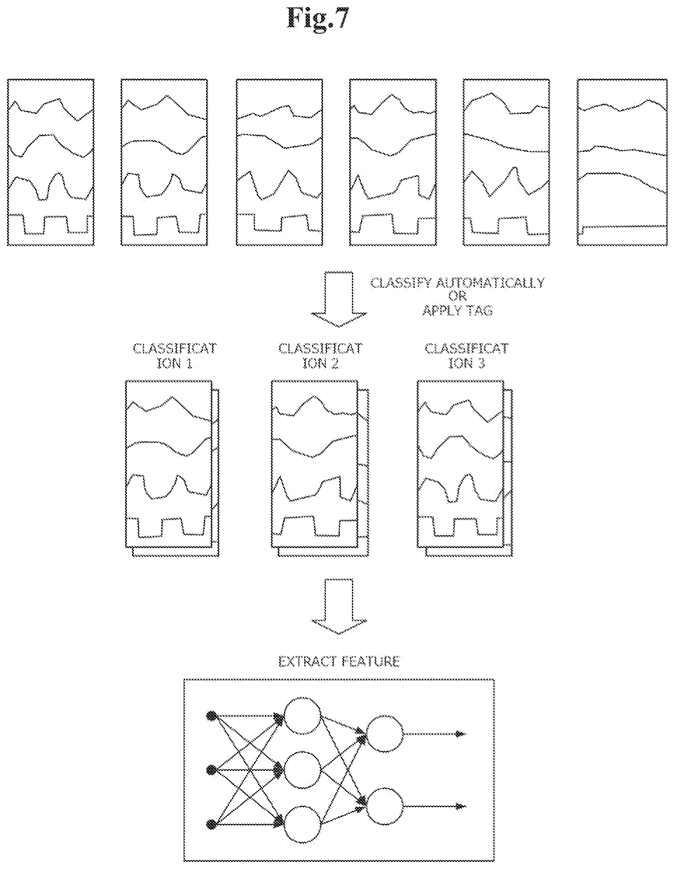

For example, the feature conversion unit 151 may be configured to calculate the feature amount by using deep learning, as illustrated in FIG. 7. For example, the feature conversion unit 151 can be configured to learn the feature amount that can express the classification of the segment best. In that case, as illustrated in FIG. 7, to each of the divided segment, a classification tag is applied manually or automatically. In the case of applying a classification tag automatically, it is possible to apply a classification tag with use of Euclidean distance between data.

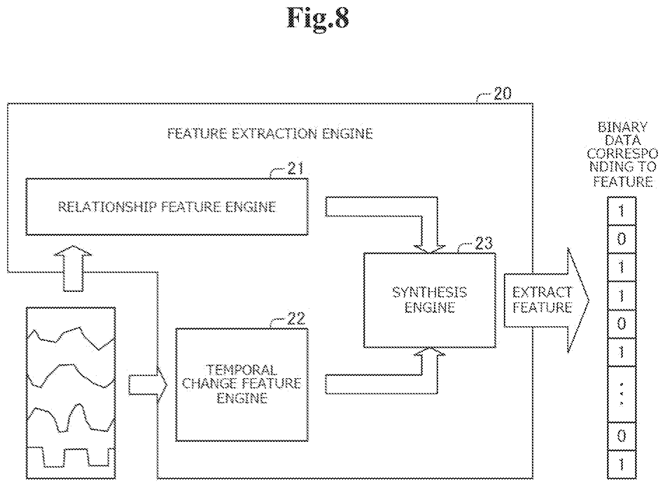

Further, the feature conversion unit 151 may be configured to calculate the feature amount with respect to each segment by using the method as described in Non-Patent Literature 1. That is, as illustrated in FIG. 8, the feature conversion unit 151 may have a feature extraction engine 20 including a relationship feature engine 21 that extracts a relationship feature between sensors, a temporal change feature engine 22 that extracts a temporal change feature, and a synthesis engine 23 that synthesize an extraction result by the relationship feature engine 21 and an extraction result by the temporal change feature engine 22. Further, the feature conversion unit 151 may be configured to perform repeated learning such as performing repeated learning by adjusting parameters based on the feature extraction result.

Note that the feature conversion unit 151 may divide time-series data such that respective segment periods do not overlap each other as illustrated in FIG. 6, or divide time-series data so as to have an overlapping period by using a moving window. That is, a segment period may overlap another segment period, or may not overlap another segment period.

The association unit 152 associates the feature amount of each segment calculated by the feature conversion unit 151 with information indicated by the abnormal case information 142. The association by the association unit 152 is performed on the basis of information indicating the time, for example.

For example, the association unit 152 checks whether or not information indicating that an abnormality occurred during the segment period exists in the abnormal case information 142. For example, in the case where there is a segment obtained by dividing one minute of “2018/7/4 0:02”, the association unit 152 confirms the abnormal case information 142 to check whether or not an abnormality occurred at “2018/7/4 0:02”. In the example of FIG. 4, the abnormal case information 142 includes information indicating that from “start date/time: 2018/7/4 0:02” to “end time/date: 2018/7/4 0:10”, “description: facility failure occurred” exists. Therefore, the association unit 152 performs association on the segment of a period including “2018/7/4 0:02”. For example, the association unit 152 sets an abnormality flag to the feature amount of the segment of the period including “2018/7/4 0:02”, and associates it with “description: facility failure occurred”. Then, the association unit 152 stores the associated information in the storage unit 140 as the past time-series feature amount information 143. Note that for a segment in which no information exists in the abnormal case information 142, the association unit 152 stores the feature amount of the segment as the past time-series feature amount information 143 without setting an abnormality flag.

As described above, the association unit 152 confirms the abnormal case information 142 to thereby check whether or not an abnormality occurred in the monitoring object P during the period of each segment calculated by the feature conversion unit 151. Then, the association unit 152 stores information corresponding to the checked result as the past time-series feature amount information 143.

The feature amount search unit 153 calculates the feature amount of the time-series data of a search object. The feature amount search unit 153 also calculates the similarity between the calculated feature amount of the search object and the feature amount included in the past time-series feature amount information 143.

The feature amount search unit 153 calculates the feature amount by the same method as that used by the feature conversion unit 151. Further, in the present embodiment, a method of calculating the similarity by the feature amount search unit 153 is not limited particularly. The feature amount search unit 153 can be configured to calculate the similarly between the calculated feature amount of the search object and the feature amount included in the past time-series feature amount information 143 by using a known method. For example, the feature amount search unit 153 can be configured to calculate the similarity by calculating the distance between the calculated feature amount of the search object and each feature amount included in the past time-series feature amount information 143.

The display information calculation unit 154 calculates various types of statistical information to be displayed on the screen display unit 120.

For example, the display information calculation unit 154 performs processing to rearrange the pieces of information for specifying past time-series data (segment) in a ranking format such as an order of similarly, on the basis of the similarity calculated by the feature amount search unit 153. That is, the display information calculation unit 154 performs processing to rearrange pieces of information for specifying past time-series data on the basis of the similarity calculated by the feature amount search unit 153, to thereby calculate the “ranking of past data” that is one of the statistical information. Note that the information for specifying the past time-series data can include, for example, date/time, presence/absence of abnormality flag, content of abnormality (description), and the like.

The display information calculation unit 154 also calculates statistical information other than ranking. For example, the display information calculation unit 154 calculates information in which the comparison results between the similarly and a predetermined threshold (any value is acceptable) are aggregated. Specifically, the display information calculation unit 154 specifies a segment to which no abnormality flag is set as a normal segment, among segments in which the similarity is equal to or lower than the predetermined threshold, for example. Then, the display information calculation unit 154 measures, for example, the number of specified normal segments, to thereby calculate “the number of similar normal segments” that is one of the statistical information. The display information calculation unit 154 also calculates the rate of “the number of similar normal segments” with respect to all normal segments to thereby calculate “the rate of similar normal segments” that is one of the statistical information. Further, the display information calculation unit 154 calculates the percentage from the top of “the number of similar normal segments” of the search object in the distribution when creating distribution of all of “the numbers of similar normal segments” in the past time-series, to thereby calculate “the percentile of the number of similar normal segments” that is one of the statistical information. By calculating the percentile, it is possible to determine whether the “number of similar normal segments” of the search object is large or small. That is, it is possible to determine whether or not the possibility of abnormality is high, for example. Further, the display information calculation unit 154 can calculate “an average distance to the normal segments” or the like as one of the statistical information.

For example, as described above, the display information calculation unit 154 calculates various types of statistical information such as “ranking of the past data”, “the number of similar normal segments”, “the rate of similar normal segments”, “the percentile of the number of similar normal segments”, and “an average distance to the normal segments”.

Note that the display information calculation unit 154 may be configured to calculate only part of the various types of statistical information illustrated above. The display information calculation unit 154 may also be configured to calculate statistical information other than those illustrated above.

The result display unit 155 displays the statistical information calculated by the display information calculation unit 154 on the screen display unit 120.

FIG. 9 illustrates an exemplary display of the result display unit 155. Referring to FIG. 9, the result display unit 155 displays, for example, the time-series data 30, a search window 31, ranking information 32, past time-series data 33 of a selected segment, other statistical information 34, and the like on the screen display unit 120.

The time-series data 30 represents time-series data included in the past time-series information 141. The time-series data 30 may be the entire time-series data included in the past time-series information 141, or time-series data from the current time (displayed time) up to a given time among the entire time-series data included in the past time-series information 141. That is, the time-series data 30 may be part of the entire time-series data included in the past time-series information 141. Further, the search window 31 shows the time-series data of the search object. Since the number of measurement values included in the search window 31 serves as a search unit, it corresponds to the number of measurement values included in each segment. This means that the size of the search window 31 is equal to the size of one segment, for example.

The ranking information 32 shows “the ranking of past data” that is one of the statistical information. In the ranking information 32, pieces of information for specifying the past time-series data (segments) are arranged in the order of similarly. For example, in the case of FIG. 9, pieces of information for specifying the past time-series data from Rank 1 to Rank 5 are arranged in the order that the closest similarly (distance) with the time-series data of the search object becomes the first. Note that the number of pieces of information displayed in the ranking information 32 may be changed as appropriate.

The past time-series data 33 of the selected segment shows time-series data of a segment selected by the user, among the pieces of information shown in the ranking information 32. For example, in the case of FIG. 9, data of Rank 3 is designated. Therefore, the past time-series data 33 of the selected segment in FIG. 9 shows the time-series data of the segment of Rank 3.

The other statistical information 34 shows various types of statistical information such as “the number of similar normal segments”, “the rate of similar normal segments”, “the percentile of the number of similar normal segments”, and “an average distance to the normal segments”.

Note that the display by the result display unit 155 is not limited to that illustrated in FIG. 9. The display by the result display unit 155 may be one other than that illustrated in FIG. 9. For example, the result display unit 155 may be configured to display only part of that illustrated above, such as displaying only part of the other statistical information 34, displaying only the ranking information 32, or the like. Further, the result display unit 155 may display one other than those illustrated above.

The exemplary configuration of the monitoring device 100 is as described above. Next, an exemplary operation of the monitoring device 100 will be described with reference to FIGS. 10 and 11. First, an exemplary operation of the monitoring device 100 for storing data will be described with reference to FIG. 10.

Referring to FIG. 10, the feature conversion unit 151 divides the time-series data shown by the past time-series information 141 into a plurality of segments each of which is partial time-series data (partial time-series) (step S101). For example, the feature conversion unit 151 divides the time-series data into a plurality of segments according to a search unit such as a unit of several points of measurement value.

The feature conversion unit 151 calculates the feature amount of each divided segment (step S102). For example, the feature conversion unit 151 calculates the feature amount by using deep learning.

The association unit 152 checks whether or not information corresponding to the segment period exists in the abnormal case information 142. When there is information in the abnormal case information 142 (Yes at step S103), the association unit 152 sets an abnormal flag to the feature amount of the segment, and associates it with the description shown by the abnormal case information 142 (step S104). Then, the association unit 152 stores the associated information in the storage unit 140 as the past time-series feature amount information 143 (step S106). On the other hand, when there is no information in the abnormal case information 142 (No at step S103), the association unit 152 does not set an abnormal flag, and does not associate it with the description shown by the abnormal case information 142 (step S104). Then, the association unit 152 stores the information in the storage unit 140 as the past time-series feature amount information 143 (step S106).

The exemplary operation of the monitoring device 100 for storing data is as described above. Next, an exemplary operation of the monitoring device 100 for searching for time-series data of a search object will be described.

Referring to FIG. 11, the feature amount search unit 153 calculates the feature amount of the time-series data of a search object (step S201). The feature amount search unit 153 calculates the feature amount by the same method as that used by the feature conversion unit 151.

The feature amount search unit 153 calculates the similarity between the calculated feature amount of the search object, and the feature amount included in the past time-series feature amount information 143 (step S202).

The display information calculation unit 154 calculates various types of statistical information on the basis of the similarity calculated by the feature amount search unit 153 (step S203). For example, as various types of statistical information, the display information calculation unit 154 calculates “the ranking of past data”, “the number of similar normal segments”, “the rate of similar normal segments”, “the percentile of the number of similar normal segments”, and “an average distance to the normal segments”, and the like.

The result display unit 155 displays the statistical information calculated by the display information calculation unit 154 on the screen display unit 120 (step S204).

The exemplary operation of the monitoring device 100 for searching for time-series data of a search object is as described above.

As described above, the monitoring device 100 includes the feature amount search unit 153, the display information calculation unit 154, and the result display unit 155. With such a configuration, the display information calculation unit 154 can calculate various types of statistical information on the basis of the similarity calculated by the feature amount search unit 153. As a result, the result display unit 155 can display the statistical information calculated by the display information calculation unit 154 on the screen display unit 120. Thereby, it is possible to display, on the screen, a result of comparison between the data of the search object and the past data, which enables a user to perform abnormality determination efficiently. That is, according to the configuration described above, it is possible to present sufficient information for performing abnormality determination to the user.

The present embodiment has been illustrated the case where the monitoring device 100 is configured of one information processing device. However, the monitoring device 100 may be configured of a plurality of information processing devices connected over a network. In the case where the monitoring device 100 is configured of a plurality of information processing devices, the monitoring device 100 may be configured of an information processing device having a function of storing data, and an information processing device that performs searching for data and calculating statistical information, for example.

Further, in the present invention, a flag is set when an abnormality has occurred in the monitoring object P, on the basis of the abnormal case information 142. However, the monitoring device 100 may be configured to automatically determine whether or not an abnormality has occurred in each segment on the basis of a model having been learned in advance, for example.

Further, the time-series data of a search object may be immediate n segments, rather than one segment. For example, as illustrated in FIG. 12, the present embodiment may be configured such that immediate three segments are used as time-series data of a search object. As described above, time-series data of a search object is not limited to one segment. In the case of using a plurality of segments as time-series data of a search object, the search result may be one in which n pieces of results are integrated, for example.

Further, the display information calculation unit 154 may be configured to, when calculating “the ranking of the past data”, aggregate those in a similar period of time such as a unit of one hour, for example. FIG. 13 illustrates an example of aggregation processing. Referring to FIG. 13, for example, “Rank: 1” and “Rank: 2” are “2018/2/10 8:50” and “2018/2/10 8:30” which are within one hour. Therefore, the display information calculation unit 154 can aggregate adjacent pieces of information existing within one hour. As a result, the pieces of information are aggregated into “Rank: 1” “2018/2/10 8:00-8:59”. When the display information calculation unit 154 performs aggregation processing as described above, the “distance” showing the similarly may be obtained by calculating an average value, for example. Further, the display information calculation unit 154 may be configured not to aggregate pieces of information if the flags are different, although the pieces or information are within one hour.

Further, the monitoring device 100 may be configured to perform output processing other than output processing for displaying on the screen display unit 120. For example, the monitoring device 100 can be configured to output a calculation result by the display information calculation unit 154 to an external device connected over a network.

Further, the monitoring device 100 can be configured to issue a warning such as an alert when the calculation result by the display information calculation unit 154 satisfies a predetermined condition. For example, the monitoring device 100 can be configured to issue a warning such as an alert on the basis of a comparison result between “the number of similar normal segments”, “the rate of similar normal segments”, “the percentile of the number of similar normal segments”, “an average distance to the normal segments” or the like, and a predetermined warning threshold (any value is acceptable). Note that a warning such as an alert may be configured to be displayed on the screen display unit 120 or output to an external device connected over a network.

Further, in the present embodiment, it has been described that when there is information in the abnormal case information 142, the association unit 152 sets an abnormal flag to the feature amount of the segment and associates it with the description in the abnormal case information 142. However, the monitoring device 100 may be configured to store only a segment in which no information exists in the abnormal case information 142, in the storage unit 140 as the past time-series feature amount information 143. That is, the monitoring device 100 may be configured not to store information of a segment in which information exists in the abnormal case information 142, in the storage unit 140 as the past time-series feature amount information 143.

### Second Exemplary Embodiment

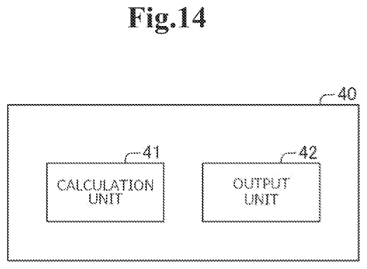

Next, a second exemplary embodiment of the present invention will be described with reference to FIG. 14. In the second exemplary embodiment, a configuration of a monitoring device 40 will be described.

The monitoring device 40 is an information processing device that performs analysis of time-series data. FIG. 14 illustrates an exemplary configuration of the monitoring device 40. Referring to FIG. 14, the monitoring device 40 includes a calculation unit 41 and an output unit 42, for example.

For example, the monitoring device 40 includes an arithmetic unit such as a CPU and a storage unit. For example, in the monitoring device 40, the arithmetic unit executes a program stored in the storage unit, whereby the various functions described above are implemented.

The calculation unit 41 calculates statistical information corresponding to a comparison result between time-series data of a search object and the past time-series data. The output unit 42 outputs the statistical information calculated by the calculation unit 41.

As described above, the monitoring device 40 includes the calculation unit 41 and the output unit 42. With such a configuration, the output unit 42 can output statistical information calculated by the calculation unit 41. Thereby, it is possible to allow the user to perform abnormality determination efficiently on the basis of the statistical information. That is, according to the configuration described above, it is possible to present sufficient information for performing abnormality determination to the user.

Further, the monitoring device 40 described above can be realized by incorporation of a predetermined program in the monitoring device 40. Specifically, a program that is another aspect of the present invention is a program for realizing, in a monitoring device, a calculation unit that calculates statistical information corresponding to a comparison result between time-series data of a search object and past time-series data, and an output unit that outputs the statistical information calculated by the calculation unit.

Further, a monitoring method to be performed to the monitoring device 40 described above is a monitoring method to be performed by a monitoring device that performs analysis of time-series data. The method includes calculating statistical information corresponding to a comparison result between time-series data of a search object and past time-series data, and outputting the calculated statistical information.

The invention of a program or a monitoring method, having the above-described configuration, also exhibits the same actions and effects as those of the monitoring device 40. Therefore, the above-described object of the present invention can be achieved by it Further, a computer-readable storage medium storing the above-described program also exhibits the same actions and effects as those of the monitoring device 40. Therefore, the above-described object of the present invention can be achieved by it.

### <Supplementary Notes>

The whole or part of the exemplary embodiments disclosed above can be described as the following supplementary notes. Hereinafter, the outlines of a monitoring method and the like of the present invention will be described. However, the present invention is not limited to the configurations described below.

### (Supplementary Note 1)

A monitoring method to be performed by a monitoring device that performs analysis of time-series data, the method comprising

calculating statistical information corresponding to a comparison result between time-series data of a search object and past time-series data, and outputting the calculated statistical information.

### (Supplementary Note 2)

The monitoring method according to supplementary note 1, further comprising

calculating the statistical information according to similarity between the time-series data of the search object and the past time-series data.

### (Supplementary Note 3)

The monitoring method according to supplementary note 2, further comprising

calculating similarity between a feature amount of the time-series data of the search object and a feature amount of a segment obtained by dividing the part time-series data into a plurality of segments.

### (Supplementary Note 4)

The monitoring method according to supplementary note 2 or 3, further comprising

performing processing to rearrange pieces of information specifying past time-series data according to the similarity between the time-series data of the search object and the part time-series data, and outputting a result of the processing of rearrangement.

### (Supplementary Note 5)

The monitoring method according to supplementary note 4, further comprising

outputting the results of the processing of rearrangement after aggregating the results according to a predetermined standard.

### (Supplementary Note 6)

The monitoring method according to any of supplementary notes 2 to 5, further comprising

calculating information by aggregating results of comparison between the similarity, between the time-series data of the search object and the past time-series data, and a predetermined threshold.

### (Supplementary Note 7)

The monitoring method according to supplementary note 6, further comprising

calculating information by aggregating data in which the similarity between the time-series data of the search object and the past time-series data becomes a predetermined threshold or lower.

### (Supplementary Note 8)

A monitoring device comprising:

a calculation unit that calculates statistical information corresponding to a comparison result between time-series data of a search object and past time-series data; and

an output unit that outputs the statistical information calculated by the calculation unit.

### (Supplementary Note 9)

The monitoring device according to supplementary note 8, wherein

the calculation unit calculates the statistical information according to similarity between the time-series data of the search object and the past time-series data.

### (Supplementary Note 10)

A computer-readable storage medium storing thereon a program for causing a monitoring device to realize:

a calculation unit that calculates statistical information corresponding to a comparison result between time-series data of a search object and past time-series data; and

an output unit that outputs the statistical information calculated by the calculation unit.

It should be noted that the program described in the exemplary embodiments and the supplementary notes may be stored in a storage device or stored on a storage medium readable by a computer. The storage medium is, for example, a portable medium such as a flexible disk, an optical disk, a magneto-optical disk, or a semiconductor memory.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

100 monitoring device
110 operation input unit
120 screen display unit
130 communication IN unit
140 storage unit
141 past time-series information
142 abnormal case information
143 past time-series feature amount information
150 arithmetic processing unit
151 feature conversion unit
152 association unit
153 feature amount search unit
154 display information calculation unit
155 result display unit
20 feature extraction engine
21 relationship feature engine
22 temporal change feature engine
23 synthesis engine
30 time-series data
31 search window
32 ranking information
33 past time-series data of selected segment
34 other statistical information
40 monitoring device
41 calculation unit
42 output unit

What is claimed is:

1. A monitoring method to be performed by a monitoring device that performs analysis of time-series data, the method comprising
calculating statistical information corresponding to a comparison result between time-series data of a search object and past time-series data, and outputting the calculated statistical information.

2. The monitoring method according to claim 1, further comprising
calculating the statistical information according to similarity between the time-series data of the search object and the past time-series data.

3. The monitoring method according to claim 2, further comprising
calculating similarity between a feature amount of the time-series data of the search object and a feature amount of a segment obtained by dividing the part time-series data into a plurality of segments.

4. The monitoring method according to claim 2, further comprising
performing processing to rearrange pieces of information specifying past time-series data according to the similarity between the time-series data of the search object and the part time-series data, and outputting a result of the processing of rearrangement.

5. The monitoring method according to claim 4, further comprising
outputting the results of the processing of rearrangement after aggregating the results according to a predetermined standard.

6. The monitoring method according to claim 2, further comprising
calculating information by aggregating results of comparison between the similarity, between the time-series data of the search object and the past time-series data, and a predetermined threshold.

7. The monitoring method according to claim 6, further comprising
calculating information by aggregating data in which the similarity between the time-series data of the search object and the past time-series data becomes a predetermined threshold or lower.

8. A monitoring device comprising:
at least one memory configured to store instructions; and
at least one processor configured to execute instructions to:
calculate statistical information corresponding to a comparison result between time-series data of a search object and past time-series data; and
output the statistical information calculated.

9. The monitoring device according to claim 8, wherein the at least one processor is configured to execute the instructions to
calculate the statistical information according to similarity between the time-series data of the search object and the past time-series data.

10. A non-transitory computer-readable storage medium storing thereon a program comprising instructions for causing a monitoring device to execute processing to:
calculate statistical information corresponding to a comparison result between time-series data of a search object and past time-series data; and
output the statistical information calculated.
